(19) United States
(12) Patent Application Publication
(10) Pub. No.: US 2012/0262930 A1
(43) Pub. Date: Oct. 18, 2012

(54) APPARATUS FOR ENHANCING LIGHT SOURCE INTENSITY

(75) Inventor: Hyeon-Bong PYO, Daejeon (KR)

(73) Assignee: Electronics and Telecommunications Research Institute, Daejeon (KR)

(21) Appl. No.: 13/436,750

(22) Filed: Mar. 30, 2012

(30) Foreign Application Priority Data
Apr. 1, 2011 (KR) 10-2011-0030308
Dec. 16, 2011 (KR) 10-2011-0136576

(51) Int. Cl. F21V 21/00

(52) U.S. Cl. 362/382

(57) ABSTRACT

Provided is an apparatus for enhancing light source intensity. The apparatus for enhancing light source intensity includes a light source outputting light having an ultrashort pulse width, a dielectric substrate, and metal nanostructures disposed on the dielectric substrate, wherein the metal nanostructures are combined with the light having an ultrashort pulse width on the dielectric substrate to generate a surface plasmon polariton resonance.

### CROSS-REFERENCE TO RELATED APPLICATIONS

This U.S. non-provisional patent application claims priority under 35 U.S.C. §119 of Korean Patent Applications Nos. 10-2011-0030308, filed on Apr. 1, 2011, and 10-2011-0136576, filed on Dec. 16, 2011, the entire contents of which are hereby incorporated by reference.

### BACKGROUND

The present invention disclosed herein relates to an apparatus for enhancing light source intensity, and more particularly, to an apparatus for enhancing the intensity of a light source by using a metal nanostructure.

Group IB noble metals, such as gold (Au), silver (Ag), or copper (Cu), have surface plasmon polariton resonance characteristics at an interface with a dielectric in ultraviolet, visible, and near-infrared regions. Particularly, in a nanostructure having a three-dimensionally constrained group IB noble metal as a medium, a localized surface plasmon resonance phenomenon occurs, which greatly enhances an electric field locally according to the size and shape of the nanostructure and dielectric properties of the surrounding medium. Therefore, the intensity of an electric field existing at a surface of the nanostructure and therearound may be greatly enhanced if the size or shape of the nanostructure is optimized according to the wavelength of light incident from a light source. That is, the nanostructure functions like an antenna in near-field or far-field.

### SUMMARY

The present invention provides an apparatus for locally enhancing the intensity of a light source by using a metal nanostructure.

The present invention is not limited to the aforesaid, and other features of the present invention will be clearly understood by those skilled in the art from descriptions below.

Embodiments of the present invention provide apparatuses for enhancing light source intensity, the apparatuses including: a light source outputting light having an ultrashort pulse width; a dielectric substrate; and metal nanostructures disposed on the dielectric substrate, wherein the metal nanostructures may generate a surface plasmon polariton resonance by being combined with the light having an ultrashort pulse width at a surface of the dielectric substrate.

In some embodiments, the light source may be a pulse wave laser having a pulse width ranging from about 5 fs to about 50 fs.

In other embodiments, the light source may be a titanium (Ti)-sapphire laser.

In still other embodiments, the light source may be a polychromatic light source or monochromatic light source.

In even other embodiments, the light source may be a gas laser or solid laser diode (LD).

In yet other embodiments, the light source may have an ultraviolet, visible, or near infrared wavelength ranging from about 300 nm to about 3000 nm.

In further embodiments, the light source may be a monochromatic light source, and the monochromatic light source may be a continuous wave (CW) laser or pulse wave laser.

In still further embodiments, the metal nanostructures may have a bowtie shape or slap dipole shape.

In even further embodiments, the metal nanostructures may be mirror-symmetric metal pairs, and a length of a major axis and a length of a minor axis of the metal pairs may be different.

In yet further embodiments, the metal nanostructures may be formed of any one selected from the group consisting of gold (Au), aluminum (Al), silver (Ag), and copper (Cu).

In much further embodiments, the apparatus for enhancing light source intensity may generate an electron beam, proton beam, or carbon ion beam.

In other embodiments of the present invention, there are provide apparatuses for enhancing light source intensity, the apparatuses including: a light source emitting an ultrashort pulse laser beam; and a target structure outputting a proton beam by enhancing intensity of the ultrashort pulse laser beam. Herein, the target structure includes: a target layer having a first surface which is irradiated with the ultrashort pulse laser beam and a second layer from which the proton beam is emitted; a support having a membrane region which is used as a propagation path of the ultrashort pulse laser beam or the proton beam; and metal nanostructures disposed on the first surface of the target layer to couple with the ultrashort pulse laser beam and generate a surface plasmon polariton resonance.

Particularities of other embodiments are included in the detailed description and drawings.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a conceptual view illustrating an apparatus for enhancing light source intensity according to an embodiment of the present invention;

FIGS. 2A through 2C are views illustrating metal nanostructures of the apparatus for enhancing light source intensity according to the embodiment of the present invention;

FIG. 3A is a near-field image illustrating electric field intensity around the metal nanostructure of the embodiment of the present invention;

FIG. 3B is a near-field image illustrating electric field intensity around a metal nanostructure according to another embodiment of the present invention;

FIG. 4 is a scanning electron microscope image showing the metal nanostructures of the embodiment of the present invention; and

FIG. 5 is a view illustrating an apparatus for enhancing light source intensity including the metal nanostructure according to another embodiment of the present invention.

### DETAILED DESCRIPTION OF THE EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining a specific exemplary embodiment while not limiting the present invention. The terms of a singular form may include plural forms unless referred to the contrary. The meaning of “comprises” and/or “comprising” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto.

Hereinafter, an apparatus for enhancing light source intensity according to embodiments of the present invention will be described in more detail with reference to the accompanying drawings.

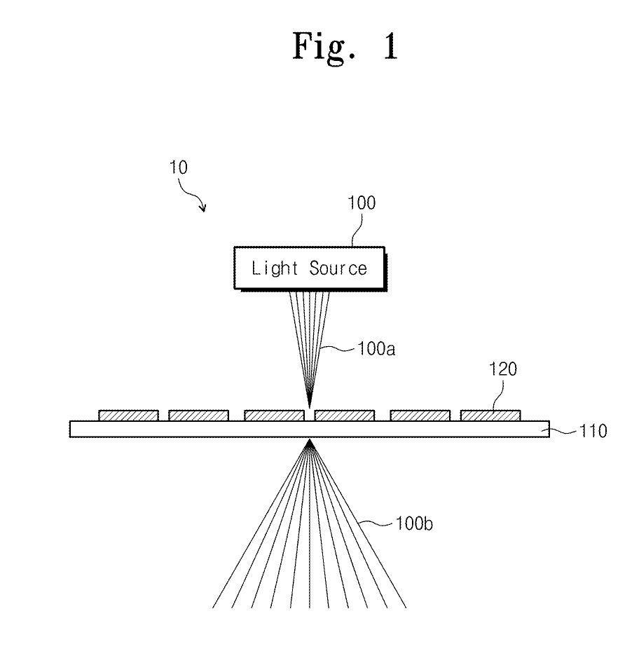

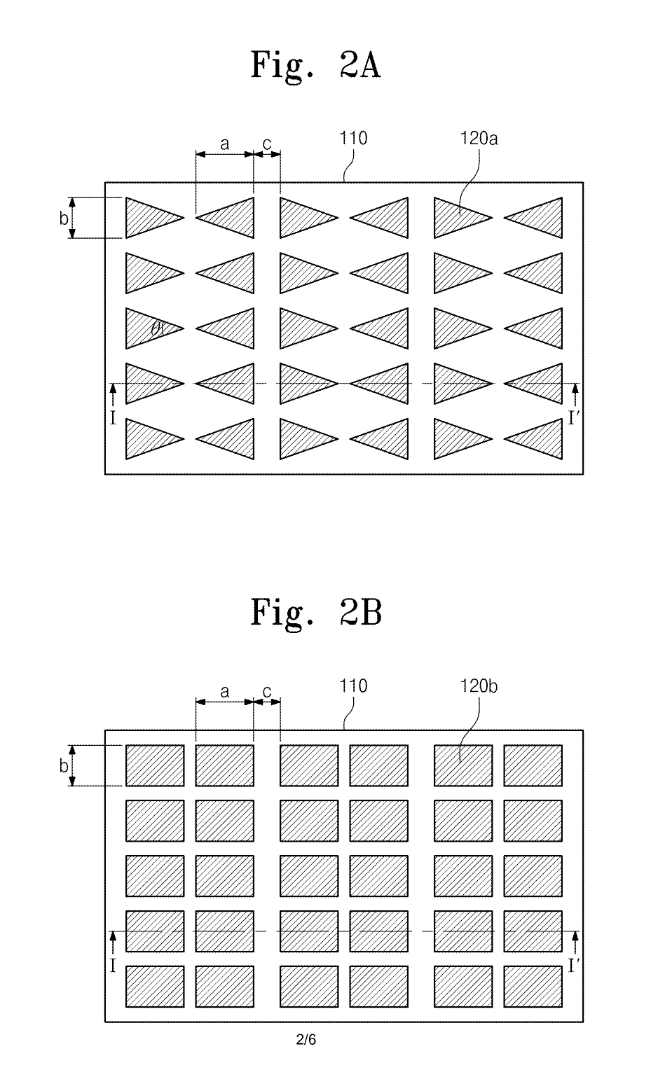

FIG. 1 is a conceptual view illustrating an apparatus 10 for enhancing light source intensity according to an embodiment of the present invention. FIGS. 2A and 2B are views illustrating metal nanostructures of the apparatus for enhancing light source intensity according to the embodiment of the present invention, and FIG. 2C is a cross section taken along line I-I′ of FIGS. 2A and 2B to illustrate the metal nanostructures of FIGS. 2A and 2B.

Referring to FIG. 1, the apparatus 10 may locally enhance an electric field of a light source 100 by using a surface plasmon polariton resonance phenomenon.

In particular, the apparatus 10 includes the light source 100, a dielectric substrate 110, and a metal nanostructures 120 disposed on the dielectric substrate 110.

The dielectric substrate 110 may be formed of a transparent dielectric through which incident light may be transmitted. For example, a glass substrate such as a silicon oxide (SiO₂) substrate may be used as the dielectric substrate 110. Alternatively, a transparent oxide, such as titanium oxide (TiO₂), tantalum oxide (Ta₂O₅), or aluminum oxide (Al₂O₃), may be used to form the dielectric substrate 110.

The metal nanostructures 120 may be metal pairs and the metal pairs may be regularly arranged on the dielectric substrate 110. The metal nanostructures 120 are mirror-symmetric metal pairs, and a major-axis length and a minor-axis length of one metal pair may be different from each other. The metal nanostructures 120 may be formed of gold (Au), silver (Ag), platinum (Pt), palladium (Pd), copper (Cu), silicon (Si), germanium (Ge), aluminum (Al), or a mixture thereof. The metal nanostructures 120 may generate surface plasmon by being combined with incident light 100a at the surface of the dielectric substrate 110. At this time, the size and shape of the metal nanostructures 120, and an inter-particle distance or lattice constant may act as parameters which greatly affect changes in resonance conditions.

According to an embodiment of the present invention, the light 100a incident on the metal nanostructures 120 may be ultrashort light. For example, an ultrashort pulse laser may be used as the light source 100 and the ultrashort pulse laser may have a pulse width ranging from several femtoseconds to several tens of femtoseconds (fs: 10⁻¹⁵ sec.).

According to an embodiment of the present invention, the light source 100 may be a polychromatic light source or monochromatic light source. A white light source such as a tungsten halogen lamp (QTH lamp) may be used as the polychromatic light source. A light source such as a gas laser, solid laser diode (LD), and ultrashort high-power laser may be used as the monochromatic light source. Further, the monochromatic light source may be a continuous wave (CW) laser or pulse wave laser. Herein, the pulse wave laser may have an ultrashort pulse width ranging from several femtoseconds to several tens of femtoseconds. The pulse wave laser may have high power ranging from several terawatts (TW: 10¹² watt) to several tens of petawatts (PW: 10¹⁵ watt) as well as low power ranging from several microwatts (μW) to several milliwatts (mW). For example, the pulse wave laser may have an intensity ranging from about 10¹⁸ W/cm² to about 10²² W/cm².

In an embodiment of the present invention, a titanium (Ti)-sapphire laser may be used as the light source 100, and the Ti-sapphire laser has a pulse width range of about 5 fs to about 50 fs and generates terawatt and petawatt power. Further, the light source 100 may generate light in a near ultraviolet (NUV), visible, or near infrared region ranging from about 300 nm to about 3000 nm.

According to an embodiment of the present invention, when ultrashort light 100a is incident on the dielectric substrate 110 with the metal nanostructures 120 formed, an electric field may be locally enhanced by surface plasmon polariton resonance characteristics. Specifically, an ultrashort light source having a short pulse width range of about 5 fs to about 50 fs may be used as the light source 100 in an embodiment of the present invention.

In particular, when a specific condition is satisfied at an interface between metal and dielectric, a surface plasmon polariton resonance, in which a light wave interacts with free electrons of a metal surface to generate a resonance, has time characteristics of femtoseconds. As a result, the light 100a having an ultrashort pulse width interacts with free electrons of metal surfaces at interfaces between the metal nanostructures 120 and the dielectric substrate 110 to generate a surface plasmon polariton resonance phenomenon. If the resonance phenomenon occurs, light 100b having enhanced scattering and absorption efficiencies in near-field and far-field can be obtained by passing the light 100a through the metal nanostructures 120. An electron, proton, or carbon ion beam may be generated from the dielectric substrate 110 by using the foregoing surface plasmon polariton resonance phenomenon. That is, according to an embodiment of the present invention, the intensity of the light 100a from the light source 100 including an ultrashort and high-power laser may be locally enhanced without using an external additional amplifying device.

According to an embodiment of the present invention illustrated in FIG. 2A, metal nanostructures 120a may have a bowtie shape. According to an embodiment of the present invention illustrated in FIG. 2b, metal nanostructures 120b may have a slap dipole shape.

Referring to FIGS. 2A to 2C, in the metal nanostructures 120a and 120b, length (a), width (b), height (d), spacing (e), angle θ, and distance (c) between the metal pairs of the metal nanostructures 120 may be adjusted in order to obtain maximum scattering and absorption efficiencies according to the wavelength of the incident light 100a.

According to an embodiment of the present invention, the length (a) of the metal nanostructures 120a and 120b may be in a range of about 100 nm to about 200 nm, the width (b) thereof may be in a range of about 50 nm to about 100 nm, and the height (d) thereof may be in a range of about 10 nm to about 100 nm. The spacing (e) between the symmetric metal nanostructures 120 may be in a range of about 50 nm to about 100 nm. In addition, the angle θ of the bowtie-shaped metal nanostructure 120a may be in a range of about 30 degrees to about 60 degrees.

Meanwhile, the metal nanostructures 120 have a spheroid shape having an oblate or prolate cross section or may have a circular, oval, triangular, rectangular, diamond shape or star shape. The shape of the metal nanostructures 120 may be varied.

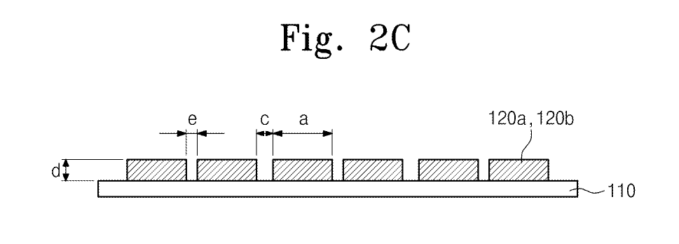

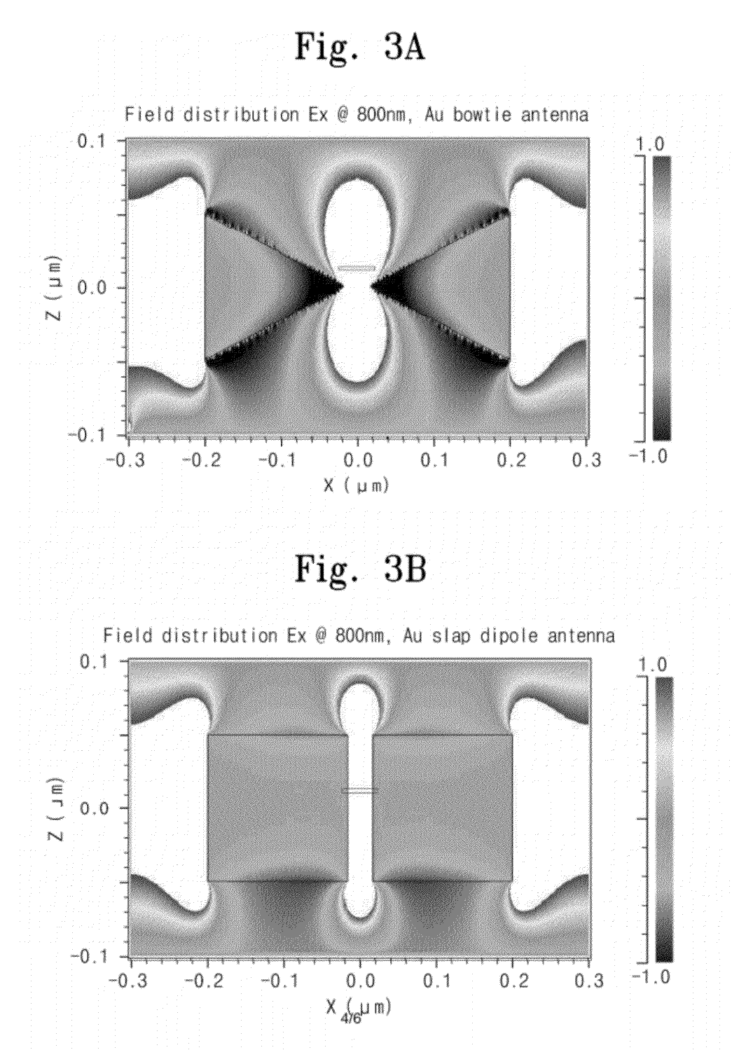

FIGS. 3A and 3B are near-field images illustrating electric field intensities around metal nanostructures according to the embodiments of the present invention.

FIGS. 3A and 3B are numerical analysis results of enhanced electric filed intensity distributions around the bowtie-shaped and slap dipole-shaped metal nanostructures, which are calculated by using a finite-difference time-domain (FDTD) method with input parameters of shape, size, and dielectric properties of the metal nanostructures in order to optimize the structures thereof.

FIG. 3A is a near-field image illustrating electric field intensity around the bowtie-shaped metal nanostructure according to the embodiment of the present invention and FIG. 3B is a near-field image illustrating electric field intensity around the slap dipole-shaped metal nanostructure according to another embodiment of the present invention, respectively.

Referring to FIGS. 3A and 3B, it may be confirmed that the electric field intensities of light sources around the metal nanostructures are enhanced when dielectric substrates with metal nanostructures formed are irradiated with laser light having an ultrashort femtosecond pulse width.

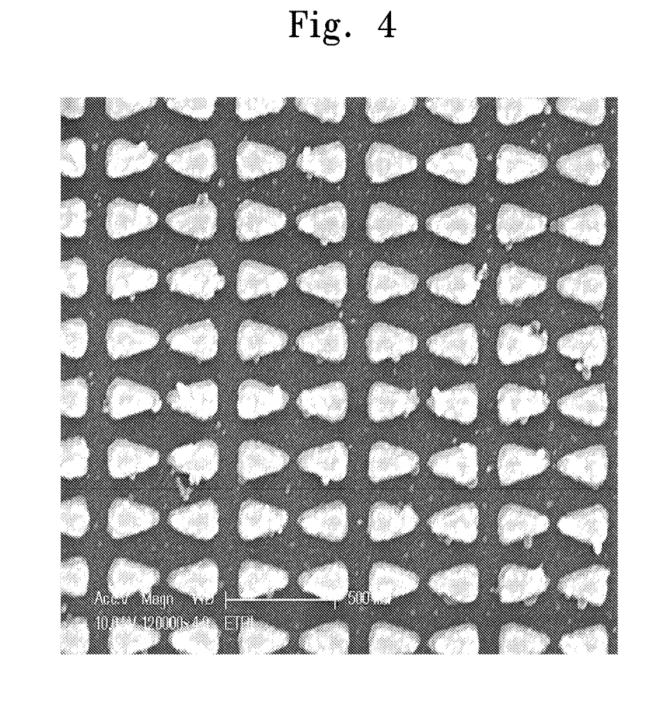

FIG. 4 is a scanning electron microscope image showing the metal nanostructures according to the embodiment of the present invention.

The scanning electron microscope image of FIG. 4 was captured from bowtie-shaped gold (Au) nanostructures formed on a quartz substrate by using an electron beam lithography method.

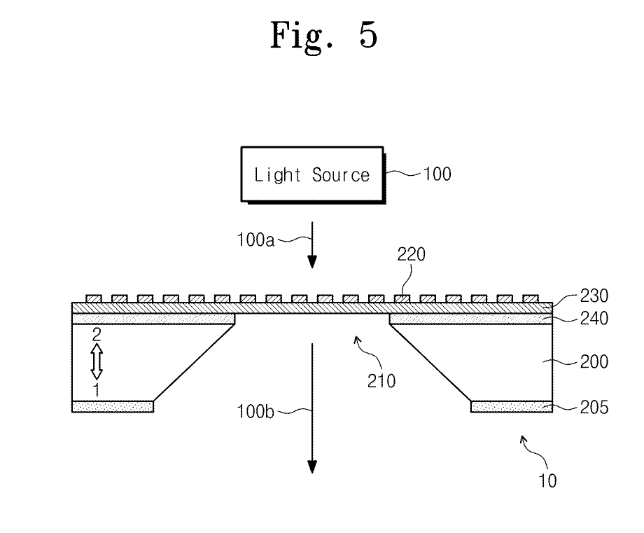

FIG. 5 is a view illustrating an apparatus for enhancing light source intensity including metal nanostructures according to another embodiment of the present invention.

Referring to FIG. 5, the apparatus for enhancing light source intensity may include a light source 100 and a target structure. The light source 100 emits light to the target structure, and the target structure outputs a charged particle beam.

The target structure may include a support 200, a target layer 230, and metal nanostructures 220. A mask pattern 205 may be formed on an upper surface 1 of the support 220, and the target layer 230 may be formed on a lower surface 2 of the support 200. Therefore, the support 200 may be disposed between the target layer 230 and the mask pattern 205. In addition, an etch stop layer 240 may be further disposed between the support 200 and the target layer 230.

In an embodiment of the present invention, the support 200 may be single crystal silicon. The support 200 may be at least one of silicon, sapphire, diamond, quartz, glass, ceramic materials, or metallic materials, and a crystal structure thereof may be single crystal, polycrystal, or amorphous. The support 200 may be formed to a thickness range of several hundreds of micrometers to several millimeters.

The support 200 includes a membrane region 210 penetrating the support 200 to expose the target layer 230. According to some embodiments, the membrane region 210 may have side walls inclined with respect to the upper surface 1 of the support 200. The mask pattern 205 is formed on the upper surface 1 of the support 200, and then the membrane region 210 may be formed by etching the support 200 using the mask pattern 205 as an etch mask. Herein, the mask pattern 205 may be formed of a material having an etch selectivity with respect to the support 200. That is, the mask pattern 205 may include a material which has an etch resistance during an etch process of the support 200. For example, if the support 200 is silicon, the mask pattern 205 may include at least one of silicon oxides, silicon nitrides, and organic polymers.

According to an embodiment of the present invention, the target layer 230 may make direct contact with the support 200. In this case, the target layer 230 may be formed of at least one of materials having an etch selectivity with respect to the support 200. For example, the target layer 230 may be formed of a transparent dielectric material through which incident light may be transmitted. For example, the target layer 230 may be formed of silicon oxide (SiO2). Alternatively, the target layer 230 may be formed of platinum, gold, silver, aluminum, titanium, or hydrogenated amorphous silicon. Additionally, the target layer 230 may contain a proton or, in general, ion-generating adlayer.

According to an embodiment of the present invention, if the etch stop layer 240 is formed between the support 200 and the target layer 230, the target layer 230 may not be damaged while the membrane region 210 is formed by etching. As a result, a material for the target layer 230 may be freely selected without substantial restrictions. For example, according to the foregoing embodiments, the target layer 230 may be at least one of inert metallic materials, aluminum, titanium, polymethyl methacrylate (PMMA), polydimethylsiloxane (PDMS), polyimide, photoresist, and hydrogenated amorphous silicon.

In an embodiment of the present invention, the metal nanostructures 220 described with reference to FIGS. 1 and 2A to 2C may be formed on one surface of the target layer 230. The metal nanostructures 220 may be metal pairs. For example, the metal nanostructures 220 may have a bowtie shape or slap dipole shape. Length (a), width (b), height (d), spacing (e), angle θ, and distance (c) between the metal pairs of each metal nanostructure 220 may be adjusted in order to obtain maximum scattering and absorption efficiencies according to the wavelength of the incident light 100a.

In the apparatus for enhancing light source intensity according to the embodiment of the present invention, the light source 100 emits ultrashort pulse laser light 100a to the metal nanostructures 220 and a surface plasmon polariton resonance phenomenon may be generated by the metal nanostructures 220. For example, the ultrashort pulse laser light 100a may have an intensity ranging from about 10¹⁸ W/cm² to about 10²² W/cm². An electric field of the ultrashort pulse laser light 100a is locally enhanced by surface plasmon polariton resonance characteristics and thus a charged particle beam 100b, such as a proton beam or ion beam, may be generated. The charged particle beam 100b may be emitted from the target layer 230 and the charged particle beam 100b may be emitted through the membrane region 210 of the support 200.

The foregoing apparatus for enhancing light source intensity according to the embodiments of the present invention may be used for a medical device for treating tumors. That is, for medical treatment, a human body may be irradiated with a charged particle beam generated from the apparatus.

According to the embodiment of the present invention, the apparatus for enhancing light source intensity can generate a localized surface plasmon polariton resonance phenomenon by using metal nanostructures so as to locally enhance the intensity of ultrashort light. That is, according to the embodiment of the present invention, the intensity of the light source including an ultrashort and high-power laser can locally be enhanced without using an external additional amplifying device.

While the present invention has been particularly shown and described with reference to exemplary embodiments thereof, it will be understood by those of ordinary skill in the art that various changes in form and details may be made therein without departing from the spirit and scope of the present invention as defined by the following claims. Thus, the above-disclosed subject matter is to be considered illustrative, and not restrictive.

What is claimed is:

1. An apparatus for enhancing light source intensity, comprising:
a light source outputting light having an ultrashort pulse width;
a dielectric substrate; and
metal nanostructures disposed on the dielectric substrate,
wherein the metal nanostructures are combined with the light having an ultrashort pulse width at a surface of the dielectric substrate to generate a surface plasmon polariton resonance.

2. The apparatus of claim 1, wherein the light source is a pulse wave laser having a pulse width ranging from about 5 fs to about 50 fs.

3. The apparatus of claim 1, wherein the light source is a titanium (Ti)-sapphire laser.

4. The apparatus of claim 1, wherein the light source is a polychromatic light source or monochromatic light source.

5. The apparatus of claim 1, wherein the light source is a gas laser or solid laser diode (LD).

6. The apparatus of claim 1, wherein the light source has an ultraviolet, visible, or near infrared wavelength ranging from about 300 nm to about 3000 nm.

7. The apparatus of claim 1, wherein the light source is a monochromatic light source, and the monochromatic light source is a continuous wave (CW) laser or pulse wave laser.

8. The apparatus of claim 1, wherein the metal nanostructures have a bowtie shape or slap dipole shape.

9. The apparatus of claim 1, wherein the metal nanostructures are mirror-symmetric metal pairs, and a length of a major axis and a length of a minor axis of the metal pairs are different.

10. The apparatus of claim 1, wherein the metal nanostructures are formed of one selected from the group consisting of gold (Au), aluminum (Al), silver (Ag), and copper (Cu).

11. The apparatus of claim 1, wherein the apparatus generates an electron beam, proton beam, or carbon ion beam.

12. An apparatus for enhancing light source intensity, comprising:
a light source emitting an ultrashort pulse laser beam; and
a target structure outputting a proton beam by enhancing intensity of the ultrashort pulse laser beam,
wherein the target structure comprises:
a target layer having a first surface which is irradiated with the ultrashort pulse laser beam and a second layer from which the proton beam is emitted;
a support having a membrane region which is used as a propagation path of the ultrashort pulse laser beam or the proton beam; and
metal nanostructures disposed on the first surface of the target layer to combine with the ultrashort pulse laser beam and generate a surface plasmon polariton resonance.

13. The apparatus of claim 12, wherein the support comprises at least one of silicon, sapphire, diamond, quartz, glass, ceramic materials, and metallic materials.

14. The apparatus of claim 12, wherein the membrane region has a width gradually increases in a direction away from the target layer.

15. The apparatus of claim 12, wherein the ultrashort pulse laser beam has a pulse width ranging from about 5 fs to about 50 fs.
